(19) United States
(12) Patent Application Publication
(10) Pub. No.: US 2006/0145003 A1
(43) Pub. Date: Jul. 6, 2006

(54) Storage device for emergency equipment

(76) Inventors: Michel Bardel, Maurepas (FR); Bernard Jean Guinot, Versailles (FR); Eric Farin, Fontenay-Sous-Bois (FR)

Correspondence Address: JOHN S. PRATT, ESQ;KILPATRICK STOCKTON, LLP, 1100 PEACHTREE STREET, ATLANTA, GA, 30309, US

(21) Appl. No.: 10/552,378

(22) PCT Filed: Apr. 5, 2004
(86) PCT No.: PCT/EP04/04262

§ 371 Date: Oct. 7, 2005

(30) Foreign Application Priority Data
Apr. 10, 2003 (FR) 0304504

(51) Int. Cl. B64D 11/00

(52) U.S. Cl. 244/118.5; 244/129.1

(57) ABSTRACT

A storage device (50) for emergency equipment (2, 17, 19) for aircraft flight crew. The storage device (50) is adapted so that the emergency equipment (2, 17, 19) in the stored position presents at least one grip surface (21) that the user can take hold of in one hand in order to place emergency equipment on the head. The emergency equipment is constituted by at least one display device (2) for displaying information, in particular information for providing assistance in flying.

The present invention relates to storage devices for emergency equipment for aircraft flight crew. This type of emergency equipment is designed to be held on the head of a user. It is generally constituted by a face mask, goggles to provide protection against smoke, and/or a device for displaying information.

More particularly, the invention relates to a storage device for emergency equipment of the above-specified type, the storage device being adapted so that when the emergency equipment is in its stored position on or in the storage device, the user can take hold of the emergency equipment via at least one grip surface, using one hand to place the emergency equipment on the head in an in-use position, while keeping said hand in substantially the same position on the grip surface. Access to the grip surface may optionally require the storage device to be opened, e.g. by initially releasing a protection and/or closure element.

Storage devices in the form of a box or a stand are already known for emergency equipment such as masks and protective goggles.

Such storage devices are important for protecting the emergency equipment they contain and they satisfy the need for having a location for storing emergency equipment in a predefined position so as to ensure that the flight crew does not waste time searching for the equipment when they need it in a hurry.

However, under certain conditions, it can arise that the flight crew desires or requires information that is not or that is no longer visible on the control panel, or that is difficult of access. This applies in particular when smoke fills the cockpit, flight crew members then needs to view quickly the information they require.

An object of the invention is to satisfy this need of flight crew members.

To this end, the invention provides a storage device which, in addition to the characteristics mentioned above, is characterized by the fact that it is adapted to receive emergency equipment constituted by at least one information display device, in particular information for providing assistance in flying, said display device being adapted to be held close to an eye of a user and to project a light signal bearing information onto the retina of said eye.

By means of these dispositions, a member of the flight crew has reliable, quick, and ergonomic access to a device enabling information to be viewed. The invention thus makes it easier to equip flight crew members with respective emergency information viewer devices.

In preferred embodiments of the invention, recourse may optionally also be had to one or more of the following dispositions:

the device includes a test device which, when activated while the emergency equipment is in the storage position, causes a test light signal to be emitted by the display device, which signal is visible to the user and enables the user to verify that the display device is operational, without it being necessary to remove the display device from its storage position and location; this disposition makes it possible not only to save time during maintenance, but also to ensure that the display device is not damaged by being wrongly handled while it is put back into the storage device, which would make the test operation pointless;

the test device includes control means for triggering emission of the test light signal by the display device and transmission means for propagating the test light signal from the display device to a display unit that is visible to the user and that enables the user to verify that the display device is operational while the emergency equipment is in the storage position;

the device includes a button acting as control means for causing the light signal to be emitted by the display device;

the device includes a light guide adapted to transmit the light signal, from the display device to the display unit;

the emergency equipment is constituted solely by a display device adapted to be removably mounted on a face mask or on protective goggles, or placed directly on the head of a user;

the emergency equipment is constituted by a face mask and the display device;

the device includes a box, itself comprising:
a frame defining a front face of a receptacle for the emergency equipment, the emergency equipment being inserted or extracted into or from the receptacle via said front face; and
at least one flap closing said front face at least in part when the emergency equipment is placed in the receptacle, and including at least one notch via which at least a portion of the grip surface projects from an outside face of the flap, i.e. out from the box, and an opening through which a light signal can appear such as a test light signal emitted by the display device;

the device comprises a stand adapted to receive protective goggles and a display device releasably and independently of each other; and

the device comprises a bag adapted to receive emergency equipment.

Other aspects, objects, and advantages of the invention appear on reading the following description of various embodiments.

The invention will be better understood with the help of the drawings, in which:

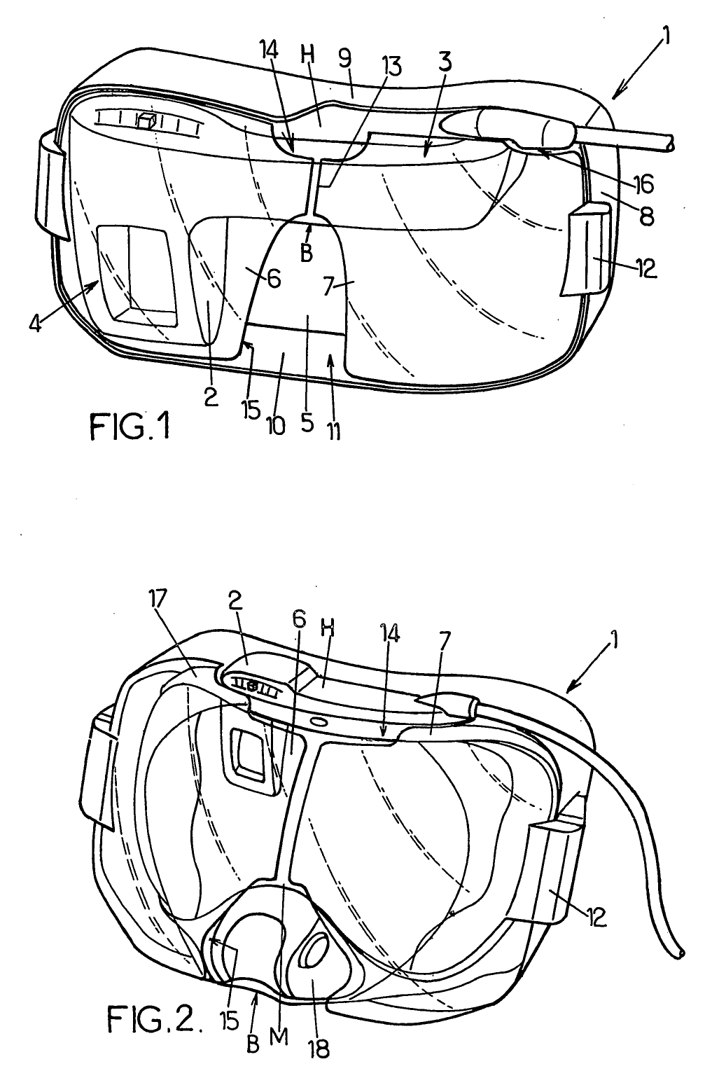

FIG. 1 is a diagrammatic perspective view of a first embodiment of the storage device of the invention, corresponding to a stand for the display device;

FIG. 2 is a perspective diagram of a second embodiment of the storage device of the invention, corresponding to a stand for protective goggles fitted with a display device;

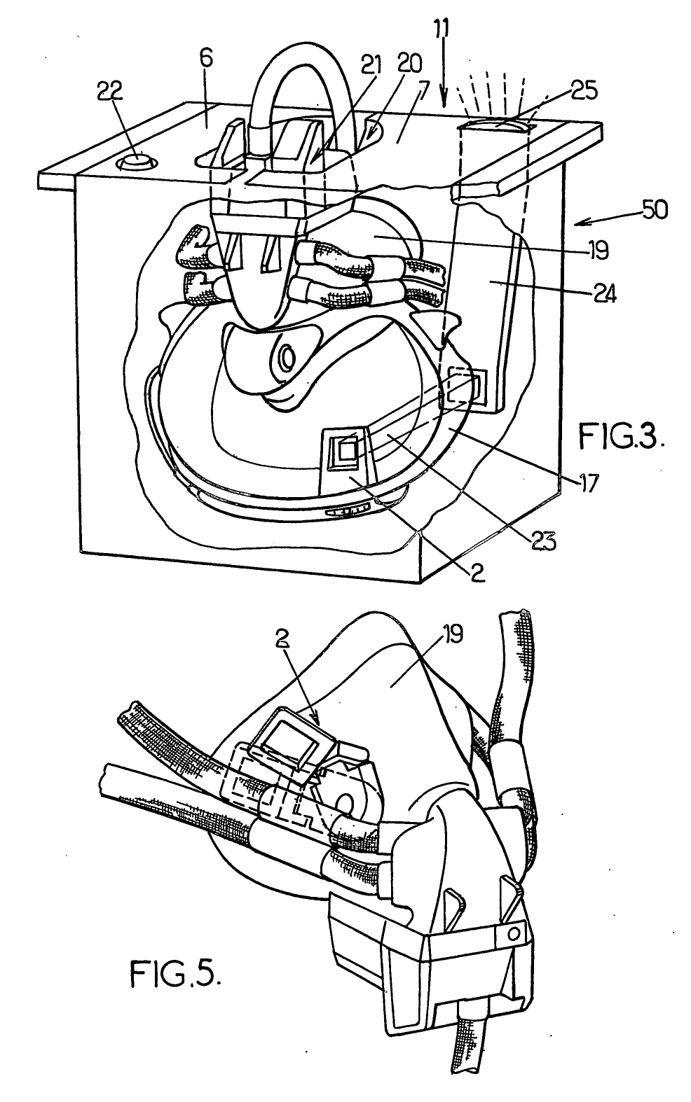

FIG. 3 is a partially cutaway diagrammatic perspective view of a third embodiment of the storage device of the invention, corresponding to a storage box for a face mask fitted with protective goggles and with a display device;

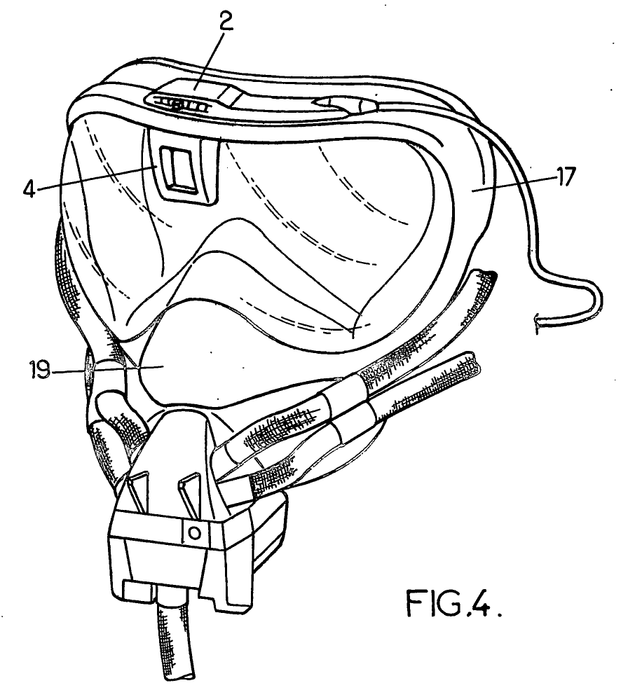

FIG. 4 is a diagrammatic perspective view of a variant of the FIG. 3 face mask;

FIG. 5 is a diagrammatic perspective view of a face mask fitted with a protective device;

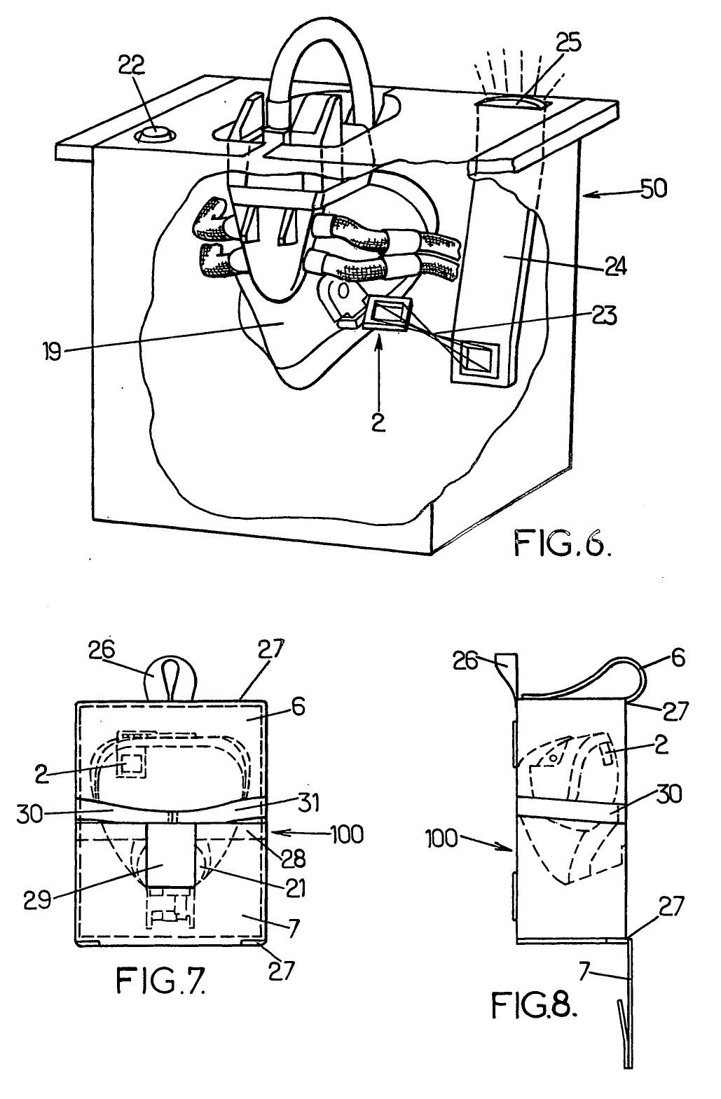

FIG. 6 is a diagrammatic view analogous to that of FIG. 3, showing a fourth embodiment of the storage device of the invention-corresponding to a storage box for a face mask fitted with a display device, as shown in FIG. 5;

FIG. 7 is a diagrammatic front view of a fifth embodiment of the storage device of the invention, corresponding to a storage bag for a breathing device fitted with protective goggles and with a display device, the storage device being shown closed; and

FIG. 8 is a diagrammatic side view of the storage device of FIG. 7, shown open.

In the figures, the same references are used to designate elements that are identical or similar.

In a first embodiment, shown in FIG. 1, the storage device of the invention is a stand box 1 for a display device 2.

By way of example, the display device 2 is of the type sold by the supplier Microvision Inc., based in Bothell in the state of Washington, USA. The display device comprises a body 3 adapted to be positioned on a user's forehead when in use, being held in said position by elastic means (not shown). The display device 2 also has optical transmission means 4 adapted to transmit an light signal and reflect it on the retina of the user when the display device is in its in-use position.

The stand box 1 comprises a back wall 5 and two doors 6 and 7. In variants, the stand box 1 could have a larger number of doors, for example it could have four doors disposed symmetrically relative to the diagonals, etc. The doors 6, 7, when considered from outside the stand box 1 and with the doors 6, 7 closed, are substantially convex. The doors 6, 7 are transparent, thus making it possible to verify that the display device 2 is present in the stand box 1.

The back wall 5 is substantially rectangular in shape, having two side walls 8, a top wall 9, and a bottom wall 10 projecting therefrom. These four walls extend substantially perpendicularly from the back wall 5 of the box, and define a substantially rectangular open face 11.

The back wall 5 rests on two projections pierced by holes suitable for fixing the stand box 1 to a support such as a partition in a cockpit, and within reach of a member of the flight crew.

Each side wall 8 is provided with a hinge 12. Each hinge 12 supports a respective door 6 or 7, enabling the door to be opened and closed about an axis that is substantially parallel to one of the short sides of the open face 11. The doors 6, 7 are hinged to the back wall 5 to move between at least two extreme positions: a closed position in which the doors 6, 7 cover at least in part the display device 2, and an open position in which the doors 6, 7 are moved apart from each other so as to allow the display device 2 to be extracted from the stand box 1.

The hinges 12 are bistable. They have a first stable position corresponding to the position in which the doors 6, 7 are closed. In this position, the hinges 12 are adapted to hold the display device 2 with sufficient force in the box 1′, between its back wall 5 and the doors 6, 7, even if the device is not pressed against the back wall 5. The hinges 12 have a second stable position corresponding to the doors 6, 7 being in the open position. This second stable position is adapted to prevent the doors 6, 7 from closing accidentally. In this way, the user can return the display device 2 into the stand box 1 with one hand since the doors 6, 7 are open.

Each door 6 or 7 has a closure edge 13 including an upper notch 14 and a lower notch 15.

The upper notch 14 of a door 6 together with the upper notch of the other door 7 serves to enable a first finger to be positioned at a location H on one edge of the display device 2. The lower notch 15 of a door 6 together with the lower notch of the other door 7 with which it co-operates to form a substantially triangular cutout enables a second finger to be positioned at a location B on another edge of the display device 2. A user can thus take hold of the display device 2 by pinching grip surfaces between two fingers at locations B and H and extract the display device 2 from the stand box 1, using one hand only. Since the convex shape of the doors 6 and 7 does not impede such extraction, there is no need for them to be opened beforehand.

While holding the display device 2 pinched in one hand, the user can, without releasing the display device 2, use the other hand to pass the elastic means around the user's head.

A cutout 16 is provided in one of the doors 6, 7 so as to pass a cable for connecting the display device 2 to a video system (not shown). In a variant, the display device operates without being connected to a video system. Under such circumstances, there is no need to provide a cutout 16.

In a variant, the display device 2 is designed to be secured to goggles for providing protection against smoke and/or to a face mask (i.e. a breathing mask covering the mouth and the nose) and/or to a so-called “full-face” mask. Under such circumstances, it is not provided with elastic means, but with means for fastening it to the goggles or to the face mask.

In a second embodiment, shown in FIG. 2, the storage device of the invention is a stand box 1 for protective goggles 17 provided with a display device 2. The display device 2 may be analogous to that described above (apart from the elastic means). In addition, the display device 2 may be mounted in fixed or releasable manner on the protective goggles 17.

The stand box 1 in this embodiment is of substantially the same shape and has substantially the same structure as that described for the first embodiment. The shapes of the upper and lower notches 14 and 15 are adapted to the shape of the protective goggles 17. More precisely, the lower notches 15 leave grip surfaces available that are disposed on locking means 18 for securing the protective goggles 17 to a face mask. Thus, the user can take hold of the protective goggles 17, either by pinching the locking means 18 or by pinching the protective goggles 17 between high and low points H and B.

In a variant, the protective goggles 17 are protective goggles that have no locking means, being held on a user's head by elastic means (not shown). Under such circumstances, the user takes hold of the protective goggles 17 so as to extract them from the stand box 1 between two fingers located substantially at point H on the top of the protective goggles 17 and at a saddle-shaped point M of the protective goggles 17 for placing on the bridge of the nose when the protective goggles 17 are in the in-use position.

In a third embodiment, shown in FIG. 3, the storage device of the invention is a storage box 50 for emergency equipment constituted by a face mask 19, protective goggles 17, and a display device 2. The storage box 50 comprises a frame defining an open front face 11 of a receptacle for the emergency equipment, the emergency equipment being inserted or extracted into or from the receptacle through said front face 11.

The storage box 50 is provided with two doors 6 and 7, each door 6, 7 having a notch 20 coinciding with the notch in the other door. These notches 20 enable grip surfaces 21 of the face mask 19 to project outside the storage box 50.

The display device 2 of the emergency equipment stored in the storage box 50 is already connected. It can be switched on by contact being made when the doors 6, 7 are opened. A test button 22 may also be placed on the outside face of one of the doors 6, 7 (in this case the door 6). The test button 22 enables the display device 2 to be switched on temporarily. A light signal 23 is then emitted by the display device 2. This light signal 23 illuminates a light guide 24. The light guide 24 transmits at least a fraction of the light generated by the display device 2 to an end forming a display unit 25. This display unit 25 is flush with one of the doors 6, 7 (in this case the door 7) via an opening made therein. Thus, without extracting the emergency equipment from the storage box 50, the user can test that the display device 2 is operational.

In a variant, the storage box 50 is adapted to receive an emergency device constituted by a so-called “full-face” mask as shown in FIG. 4 and constituted by a face mask 19 and protective goggles 17 connected to each other in permanent manner. A display device 2 is placed on the protective goggles 17 and it may be attached thereto in temporary or permanent manner. In the variant shown in FIG. 4, the display device 2 has optical transmission means 4 disposed inside the protective goggles 17 while they are in place on the face of a user. In a variant that is not shown, the display device 2 may be secured to the protective goggles 17 so that the optical transmission means 4 are outside the protective goggles 17 when they are in place on the face of the user.

In a fourth embodiment, shown in FIGS. 5 and 6, the storage device of the invention is a storage box 50 for emergency equipment constituted by a face mask 19 and by a display device 2.

As shown in FIG. 5, the face mask 19 is of a known type (see for example document EP 0 288 391). This face mask 19 has the display device 2 mounted thereon in stationary and/or removable and/or hinged manner.

As shown in FIG. 6, in the fourth embodiment, the storage box 50 is substantially analogous to that described with reference to the third embodiment. As described above, it is provided with transmission means such as a light guide 24 for propagating an optical test signal 23 and control means such as a test button 22 for causing the light signal 23 to be emitted.

In a variant (not shown), the storage device of the invention is adapted to receive a face mask 19 with or without protective goggles 17, having the display device 2 mounted thereon. When the display device 2 is in its storage position in the storage device, it occupies a fixed retracted position, e.g. against the outside face of the face mask 19. Under such circumstances, the means 23 for transmitting the test light signal can be disposed differently from that shown in FIGS. 3 and 6. For example, a light guide may be placed on a side wall facing the display device (i.e. on a wall of the box 50 perpendicular to the wall on which the light guide 24 is located in FIGS. 3 and 6).

In another variant (not shown), the storage device of the invention is adapted to receive a so-called “full-face” mask as shown in FIG. 4, but including a display device 2 mounted not on the protective goggles 17, but on the face mask 19, as shown in FIG. 5.

In yet another variant, the cable connecting the display device 2 to a video system is integrated in the protective goggles 17 and/or in the face mask 19, and is then secured to pipes for feeding the face mask 19 with breathing gas.

In a fifth embodiment, shown in FIGS. 7 and 8, the storage device of the invention is a flexible box or bag 100. The bag 100 is substantially in the form of a rectangular parallelepiped with a loop 26 for enabling it to be hung in a substantially vertical position. The front face 11 of the bag 100 is closed by a bottom door 7 and a top door 6. By way of example, the doors 6 and 7 are made of fabric. The doors 6 and 7 open and close by folding about folds 27 that extend substantially horizontally when the bag 100 is suspended via the loop 26. Each door 6 or 7 covers substantially half of the front face 11. The doors overlap in a zone where they are connected together by Velcro® type fasteners 28. A handle 29 connected to the bottom door 7 close to a fastener 28 serves, when pulled, to separate the doors 6 and 7 from each other so as to open the bag 100. Two strips 30 and 31 each fixed to a respective side wall of the bag 100 have their free ends connected together by fixing means, e.g. of the Velcro® type, so as to retain the emergency device constituted in this case by a face mask 19 fitted with protective goggles 17 and a display device 2, when the lower door 7 is hanging down, leaving uncovered the bottom half of the bag 100 (see FIG. 8). Grip surfaces 21 of the face mask 19 are then visible and accessible, projecting under the bottom door 6. The user can thus take hold of these grip surfaces 21, pull on the emergency device as a whole, and extract it from the bag 100. While this movement is taking place, the strips 30 and 31 separate, thereby releasing the emergency device which the user can then don on the head.

1-11. (canceled)

12. A storage device for emergency equipment for members of aircraft flight crew, said emergency equipment being designed to be held on a head of a user, said storage device being adapted so that when said emergency equipment is in a stored position on or in said storage device, the user can take hold of said emergency equipment via at least one grip surface, using one hand to place said emergency equipment on the head in an in-use position while keeping said hand in substantially a same position on said grip surface, said storage device being adapted to receive said emergency equipment constituted by at least one information display device, said display device being adapted to be held close to an eye of a user and to project a light signal bearing information onto the retina of said eye.

13. A device according to claim 12, including a test device which, when activated while said emergency equipment is in said storage position, causes a test light signal to be emitted by said display device, which signal is visible to the user and enables the user to verify that said display device is operational.

14. A device according to claim 13, in which said test device includes control means for triggering emission of said test light signal by said display device and transmission means for propagating said test light signal from said display device to a display unit that is visible to the user and that enables the user to verify that said display device is operational while said emergency equipment is in said storage position.

15. A device according to claim 14, including a light guide adapted to transmit said light signal, from said display device to said display unit.

16. A device according claim 12, including a button acting as control means for causing said light signal to be emitted by said display device.

17. A device according to claim 12, in which said emergency equipment is constituted solely by a display device adapted to be removably mounted on one of a face mask and protective goggles, or placed directly on the head of a user.

18. A device according to claim 12, in which said emergency equipment is constituted by a face mask and said display device.

19. A device according to claim 12, in which said emergency equipment is constituted by a face mask, protective goggles, and said display device.

20. A device according to claim 12, comprising a box itself comprising:
a frame defining a front face of a receptacle for said emergency equipment, said emergency equipment being inserted and extracted respectively into and from said receptacle via said front face; and
at least one flap closing said front face at least in part when said emergency equipment is placed in said receptacle, and including at least one notch via which at least a portion of said grip surface projects from an outside face of said flap, and out from said box, and an opening through which a light signal can appear such as a test light signal emitted by the display device.

21. A device according to claim 12, comprising a stand adapted to receive protective goggles and a display device releasably and independently of each other.

22. A device according to claim 12, comprising a bag adapted to receive said emergency equipment.
